(19) United States
(12) Patent Application Publication
(10) Pub. No.: US 2021/0179114 A1
(43) Pub. Date: Jun. 17, 2021

(54) System For Monitoring Driving Behaviour In GPS Denied Environment

(71) Applicant: Tangerine Innovation Holding Inc., Menlo Park, CA (US)

(72) Inventors: Sumit Rishi, Bangalore (IN); Ayush Kochhar, Rajasthan (IN)

(21) Appl. No.: 17/120,849

(22) Filed: Dec. 14, 2020

Related U.S. Application Data
(60) Provisional application No. 62/947,549, filed on Dec. 13, 2019.

(51) Int. Cl. B60W 40/10; B60W 30/095; B60W 40/09; G01C 21/16

(52) U.S. Cl. CPC B60W 40/10; B60W 30/095; B60W 2540/30; G01C 21/16; B60W 2510/18; B60W 40/09

(57) ABSTRACT

System and method for assessing driving behaviour and hard events in a vehicle in a GPS denied environment are disclosed. One or more first driving parameters are recorded using sensors such as accelerometer and gyroscope. A method for numerically reorienting the sensor parameters is also disclosed. The method computes the second driving parameters along the longitudinal, lateral and vertical axes of the vehicle based on the forces acting along the lateral axis of the vehicle is minimum when the vehicle is being driven along a straight path with non-zero acceleration. A method for detecting the hard events is also disclosed which detects the events that are symptomatic of unsafe driving. The detected events are then mapped to a score that can be used to measure safety and comfort of the drive and assess driving behaviour.

### RELATED APPLICATION

The present application claims the benefit of priority under 35 U.S.C. § 119 from U.S. Provisional Patent Application Ser. No. 62/947,549 entitled “Driving Behavior Event Detection in GPS Denied Environment,” filed on Dec. 13, 2019, the disclosure of which is hereby incorporated by reference in its entirety for all purposes.

### TECHNICAL FIELD

The present invention generally relates to a system and a method for monitoring driving behaviour and a behaviour assessment device thereof.

### BACKGROUND OF THE INVENTION

With advances in technology and more of the computing being available on the edge, fleet owners and operators are looking at leveraging technology to ensure safety of their assets both human and automotive. Personal mobility is also witnessing a transformation in concept that can be described as Mobility-as-a-Service (MaaS) where a shift is happening from personally-owned modes of transportation and towards mobility provided as a service. The service provider would need ways to measure the performance of their vehicles and drivers in ways that would not distract the driver. In addition, with a growing network of transportation, implementation of dynamic automobile insurance premiums that incentivize and promote good driving practices is assessing the driving habits of the driver in the actual working scenarios. Thus, the driver behaviour scoring will be central to the services offered for ride hailing, employee transportation, other fleet operations and safety of the public at large.

Fleets are leveraging recent advances in technology—AI, IOT and Connectivity to ensure safety of their assets, both human and automotive. Many corporations involved in telematics, smart transportation and insurance tech are using sensor data to study the driver behaviour in real time. The system and method deployed always uses inertial measurements from sensors as well as the GPS and magnetometers. GPS signal however is susceptible to interference from weather phenomenon as well as obstruction/reflection from manmade and natural structures. In large cities with high rises the problem is even more severe. Most of the systems that rely on GPS, thus, fail to perform real time measurement of the driver behaviour and have periods of prolonged degraded performance.

### SUMMARY

This section is provided to introduce certain objects and aspects of the present invention in a simplified form that are further described below in the detailed description. This summary is not intended to identify the key features or the scope of the claimed subject matter. In order to overcome at least a few problems associated with the known solutions as provided in the previous section, an object of the present invention is to provide a system and a method for monitoring a driving behaviour using a behaviour assessment device. Another object of the present invention is to provide a system and a method for determining a driving score based on the monitoring of the driving behaviour. Yet another object of the present invention is to provide a system and a method for monitoring driving behaviour in a GPS-denied environment. Yet another object of the present invention is to provide a dedicated and a standalone behaviour assessment device for monitoring driving behaviour in a GPS-denied environment.

In order to achieve at least some of the above-mentioned objectives, the present invention provides a method and system for monitoring a driving behaviour using a behaviour assessment device in a GPS-denied environment. A first aspect of the present invention relates to a method for monitoring a driving behaviour using a behaviour assessment device in a GPS-denied environment. The method comprises receiving, at a transceiver unit of the behaviour assessment device, at least one first driving parameter from at least one of an accelerometer and a gyroscope of a measuring device along at least one of a longitudinal axis, a vertical axis and a lateral axis of the measuring device. Next, a processor of the behaviour assessment device detects an initiation of at least one trip on a vehicle. Further, the processor of the behaviour assessment device calculates at least one third driving parameter along a modified first axis and a modified second axis in a horizontal plane of the vehicle based on the at least one first driving parameter. Subsequently, the processor of the behaviour assessment device dynamically calculates a reorientation angle between at least one of a longitudinal axis and a lateral axis of the vehicle and one of the modified first axis and the modified second axis using a numerical reorientation technique based on minimizing lateral forces in the lateral axis of the vehicle for the vehicle driving straight with non-zero acceleration. Further, the processor of the behaviour assessment device automatically calculates at least one second driving parameter along each of the longitudinal axis and the lateral axis of the vehicle based on a combination of the reorientation angle and a vector component of the at least one third driving parameter. Furthermore, the processor of the behaviour assessment device monitors the driving behaviour during a duration of the at least one trip based on the at least one second driving parameter along coordinate axes of the vehicle.

Another aspect of the present invention relates to a behaviour assessment device. The behaviour assessment device comprises a transceiver unit, a memory unit and a processor, all components connected to each other. The transceiver unit is configured to receive at least one first driving parameter from at least one of an accelerometer and a gyroscope of a measuring device along at least a longitudinal axis, a vertical axis and a lateral axis of the measuring device. The processor is configured to detect an initiation of at least one trip on a vehicle. The processor is further configured to calculate at least one third driving parameter along a modified first axis and a modified second axis in a horizontal plane of the vehicle based on the at least one first driving parameter. The processor is also configured to dynamically calculate a reorientation angle between at least one of a longitudinal axis and a lateral axis of the vehicle and one of the modified first axis and the modified second axis using a numerical reorientation technique based on minimizing lateral forces in the lateral axis of the vehicle for the vehicle driving straight with non-zero acceleration. The processor is also configured to automatically calculate at least one second driving parameter along each of the longitudinal axis and the lateral axis of the vehicle based on a combination of the reorientation angle and a vector component of the at least one third driving parameter. The processor is also configured to monitor the driving behaviour during a duration of the at least one trip based on the at least one second driving parameter along coordinate axes of the vehicle.

Another aspect of the present invention relates to a system for monitoring driving behaviour using a behaviour assessment device in a GPS denied environment. The system comprises a measuring device and a behaviour assessment device. The measuring device comprises at least one of an accelerometer and a gyroscope, said measuring device is configured to collect at least one first driving parameter from at least one of the accelerometer and the gyroscope of the measuring device along at least one of a longitudinal axis, a vertical axis and a lateral axis of the measuring device. The measuring device is also configured to transmit, to the behaviour assessment device, the at least one first driving parameter along at least one of the longitudinal axis, the vertical axis and the lateral axis of the measuring device. The behaviour assessment device comprises a transceiver unit, a memory unit and a processor, all components connected to each other. The transceiver unit is configured to receive at least one first driving parameter from at least one of the accelerometer and the gyroscope of the measuring device along at least one of the longitudinal axis, the vertical axis and the lateral axis of the measuring device. The processor is configured to detect an initiation of at least one trip on a vehicle. The processor is further configured to calculate at least one third driving parameter along a modified first axis and a modified second axis in a horizontal plane of the vehicle based on the at least one first driving parameter. The processor is also configured to dynamically calculate a reorientation angle between one of a longitudinal axis and a lateral axis of the vehicle and one of the modified first axis and the modified second axis using a numerical reorientation technique based on minimizing lateral forces in the lateral axis of the vehicle for the vehicle driving straight with non-zero acceleration. The processor is also configured to automatically calculate at least one second driving parameter along each of the longitudinal axis and the lateral axis of the vehicle based on a combination of the reorientation angle and a vector component of the at least one third driving parameter. The processor is also configured to monitor the driving behaviour during a duration of the at least one trip based on the at least one second driving parameter along coordinate axes of the vehicle.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

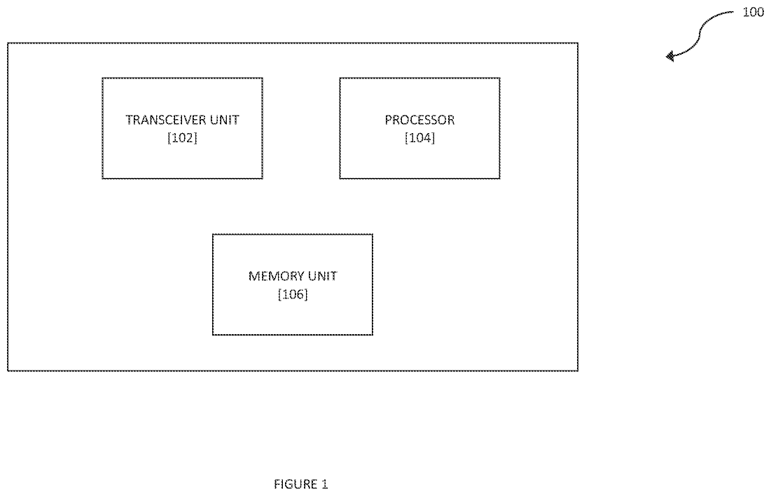

Referring to FIG. 1 illustrates an exemplary block diagram of a behaviour assessment device [100], in accordance with exemplary embodiments of the present invention.

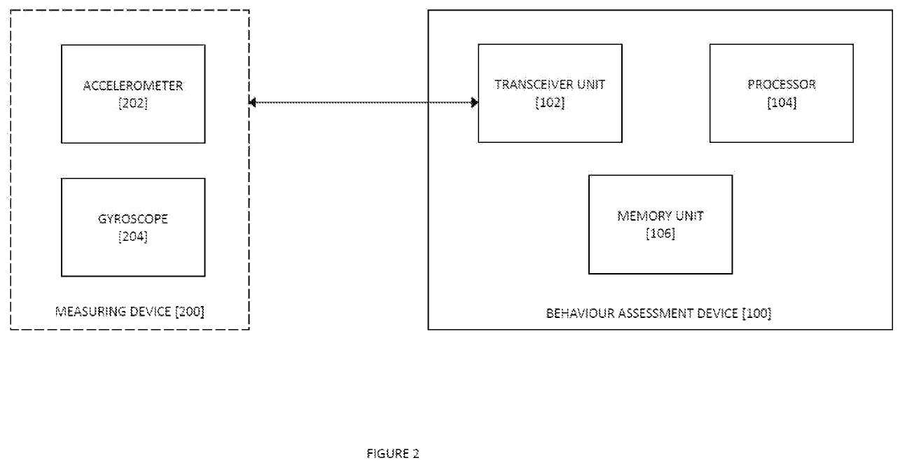

Referring to FIG. 2 illustrates a system for monitoring a driving behaviour using a behaviour assessment device [100], in accordance with the exemplary embodiments of the present invention.

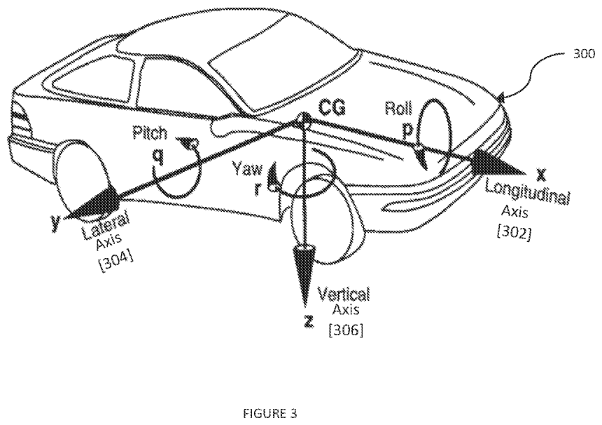

Referring to FIG. 3 illustrates the coordinate axes of a vehicle, in accordance with the exemplary embodiments of the present invention.

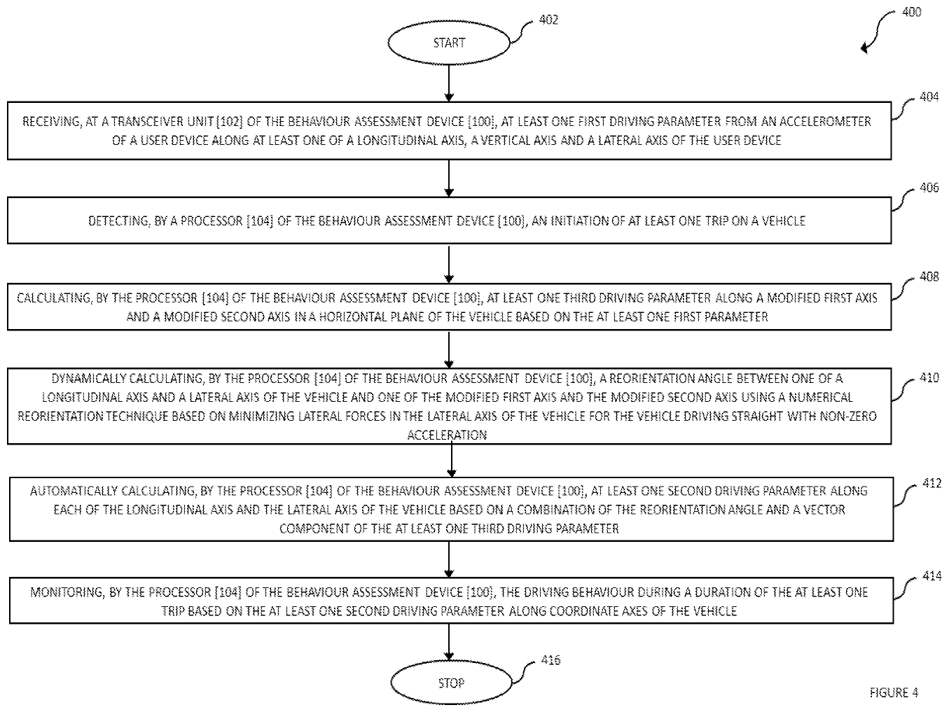

Referring to FIG. 4 illustrates an exemplary flow diagram depicting a method

for monitoring a driving behaviour using a behaviour assessment device [100], in accordance with exemplary embodiments of the present invention.

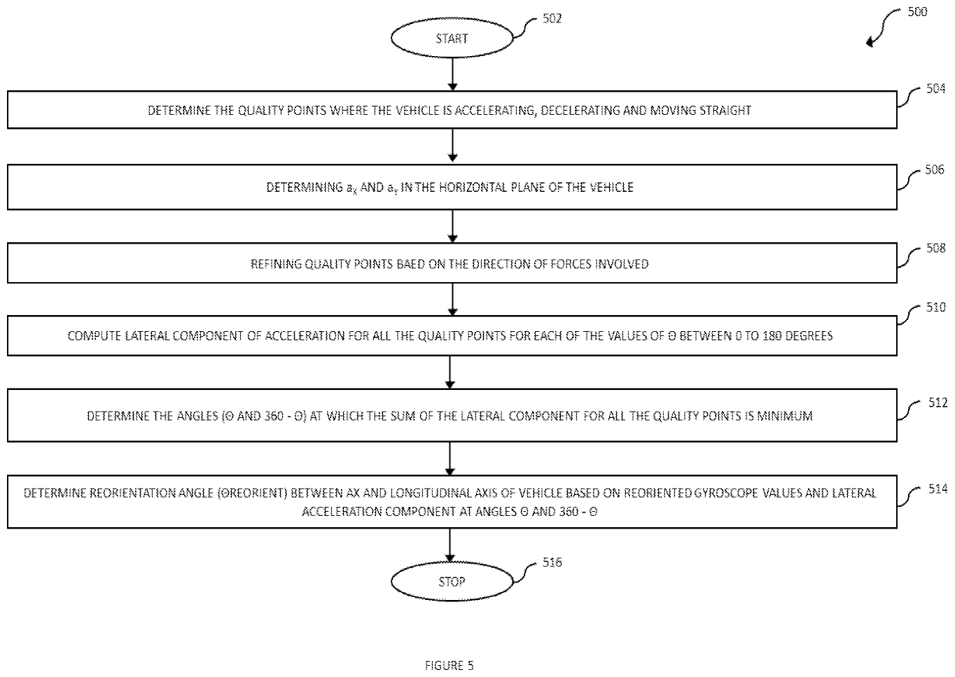

Referring to FIG. 5 illustrates an exemplary numerical reorientation sub-method of the present invention, in accordance with exemplary embodiments of the present invention.

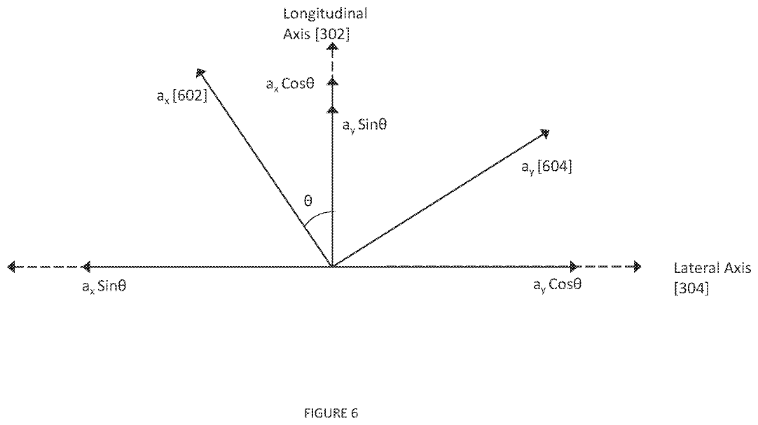

Referring to FIG. 6 illustrates an exemplary vector representation of the acceleration in the axes of the measuring device [200] and the coordinate axes of the vehicle.

The foregoing shall be more apparent from the following more detailed description of the disclosure.

### DETAILED DESCRIPTION OF THE EXEMPLARY EMBODIMENTS

In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a sequence diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, “a measuring device” comprises of one or more sensors including, but not limited to, an accelerometer, a gyroscope, a magnetometer, a pressure sensor, a temperature sensor, an occupancy sensor, a mass airflow sensor, an engine speed sensor, an oxygen sensor, a spark knock sensor, a coolant sensor, a fuel temperature sensor, a voltage sensor, a camshaft position sensor, a throttle position sensor, etc. The “measuring device” is capable of collecting data from the one or more sensors, and of sharing the collected data with a computational unit (e.g., behaviour assessment device, server, etc.). In an instance, the measuring device is an inertial measurement unit (IMU) further comprising of one or more of an accelerometer and a gyroscope to determine acting forces, an angular velocity, magnetic fields and orientation, etc. for an object. In another instance, the measuring device can also be a “user device”, and the one or more sensors reside in the user device. Moreover, terms like “user device”, “smart computing device”, “device”, “terminal,” “handset,” and similar terminology refers to any electrical, electronic, electro-mechanical computing device or equipment or a combination of one or more of the above devices. Smart computing devices may include, but not limited to, a mobile phone, smartphone, virtual reality (VR) devices, augmented reality (AR) devices, pager, laptop, a general-purpose computer, desktop, personal digital assistant, tablet computer, mainframe computer, or any other computing device as may be obvious to a person skilled in the art. In general, a smart computing device is a digital, user-configured, computer networked device that can be operated autonomously. The smart computing device may also have additional features of a touch screen, apps ecosystem, physical and biometric security, etc. These smartphones can access the Internet, have a touchscreen user interface, can run third-party apps including capability of hosting online applications, music players and are camera phones possessing high-speed mobile broadband 4G LTE internet with video calling, hotspot functionality, the one or more sensors, mobile payment mechanisms and enhanced security features with alarm and alert in emergencies. Mobility devices may include smartphones, wearable devices, smart-watches, smart bands, wearable augmented devices, etc. For the sake of specificity, the mobility device is referred to both feature phone and smartphones in present disclosure but does not limit the scope of the disclosure and may extend to any mobility device in implementing the technical solutions. The above smart devices including the smartphone as well as the feature phone including IoT devices enable the communication on the devices. Further, the foregoing terms are utilized interchangeably in the subject specification and related drawings.

As used herein, a “processor” or “processing unit” includes one or more processors, wherein processor refers to any logic circuitry for processing instructions. A processor may be a general-purpose processor, a special-purpose processor, a conventional processor, a digital signal processor, a plurality of microprocessors, one or more microprocessors in association with a DSP core, a controller, a microcontroller, a low-end microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

Existing solutions in the field of monitoring driving behaviour utilize GPS data from a user device for their computations. However, the GPS data may not always be available especially when the end user has the ability to turn off the GPS as can be done in modern cell phones or in crowded cities where the effect of urban canyon interferes with the accuracy of the GPS readings. Thus, in order to resolve the above highlighted and other inherent limitations in the existing solutions, the present invention provides a system and a method for monitoring a driving behaviour using a behaviour assessment device in a GPS-denied environment. The solution of the present invention provides that a device collecting data from the sensors (accelerometer and gyroscope) for the duration for which the vehicle's engine is running, and numerically reorienting the collected data from the accelerometer and gyroscope to the coordinate axes of the vehicle irrespective of the orientation of the device with respect to the car's coordinate axes and frequent movement of the device as a trip is in progress. The driving behaviour is monitored on the basis of the reoriented data of the accelerometer and the gyroscope.

Hereinafter, exemplary embodiments of the present disclosure will be described in detail with reference to the accompanying drawings so that those skilled in the art can easily carry out the present disclosure.

Referring to FIG. 1 illustrates an exemplary block diagram of a behaviour assessment device [100], in accordance with exemplary embodiments of the present invention. The behaviour assessment device [100] comprises of a transceiver unit [102], a memory unit [106] and a processor [104], all the components are connected to each other unless otherwise indicated and work in conjunction to achieve the objectives of the present invention. The present invention encompasses that the behaviour assessment device [100] starts operating, for an instance, after a trip on a vehicle is completed to assess the driving behaviour for a driver of the vehicle for at least one trip. In another instance, the present invention encompasses that the behaviour assessment device [100] starts operating upon initiation of a trip. In yet another instance, the present invention encompasses that the behaviour assessment device [100] starts operating for an ongoing trip.

The transceiver unit [102] is connected to the memory unit [106] and the processor [104]. The transceiver unit [102] of the behaviour assessment device [100] is configured to receive at least one first driving parameter from at least one of an accelerometer and a gyroscope of a measuring device [200] along at least one of a longitudinal axis, a vertical axis and a lateral axis of the measuring device [200] at a transceiver unit [102] of the behaviour assessment device [100]. The transceiver unit [102] of the behaviour assessment device [100] is configured to transmit the received at least one first driving parameter to the processor [104] of the behaviour assessment device [100].

For example, the transceiver unit [102] of the behaviour assessment device [100] receives the at least one first driving parameter from the measuring device [200] over a wired or a wireless connection. The present invention encompasses that the at least one first driving parameter is the acceleration in at least one of the longitudinal axis, the vertical axis and the lateral axis of the measuring device [200] as measured by the accelerometer of the measuring device [200]. The present invention encompasses that the at least one first driving parameter is the angular velocity as measured by the gyroscope of the measuring device [200]. The present invention encompasses that the transceiver unit [102] of the behaviour assessment device [100] receives the at least one first driving parameter, for instance, continuously. In another instance the present invention encompasses that the transceiver unit [102] of the behaviour assessment device [100] receives the at least one first driving parameter periodically.

The processor [104] is connected to transceiver unit [102] and the memory unit [106]. The processor [104] of the behaviour assessment device [100] is configured to receive the at least one first driving parameter from the transceiver unit [102] of the behaviour assessment device [100], wherein the at least one first driving parameter is received from at least one of the accelerometer and the gyroscope of the measuring device [200] in at least one of the longitudinal axis, the vertical axis and the lateral axis of the measuring device [200]. The processor [104] of the behaviour assessment device [100] is also configured to detect an initiation of at least one trip on a vehicle. In an instance, the present invention encompasses that the processor [104] of the behaviour assessment device [100] detects an initiation of at least one trip on a vehicle based on the at least one first driving parameter. For example, for a vehicle initially at rest, the processor [104] detects an initiation of a trip for the vehicle based on the at least one first driving parameters. In another instance, the present invention encompasses that the processor [104] of the behaviour assessment device [100] detects an initiation of the at least one trip on a vehicle based on an input received from an interface of the vehicle, wherein the processor [104] is configured to communicate with the vehicles' interface.

The processor [104] of the behaviour assessment device [100] is also configured to calculate at least one third driving parameter along a modified first axis and a modified second axis in a horizontal plane of the vehicle based on the at least one first driving parameter. In this regard, the present invention further encompasses that the processor [104] of the behaviour assessment device [100] is configured to determine a vertical reorientation angle between the vertical axis of the measuring device [200] and the vertical axis of the vehicle, and to calculate at least one second driving parameter along the vertical axis of the vehicle based on the at least one first driving parameter along the vertical axis of the measuring device [200] and the vertical reorientation angle. The processor [104] of the behaviour assessment device [100] separates the gravity to a known axis using the at least one first driving parameters received from the gyroscope and the accelerometer of the measuring device [200], thus, aligning the coordinate axes of the measuring device with the gravity using trigonometric identities and vector algebra techniques.

Separating the gravity from the coordinate axes of the measuring device affects all the three components of the coordinate axes and the at least one first driving parameters along the lateral axis, the vertical axis and the longitudinal axis, thus, generating new vector components. Accordingly, the processor [104] of the behaviour assessment device [100] is further configured to calculate at least one third driving parameter along the modified first axis and the modified second axis in a horizontal plane of the vehicle based on a combination of at least one first driving parameter and the above calculated at least one second driving parameter of the vertical axis of the vehicle, wherein the at least one third driving parameter comprises of a first component along the modified first axis and longitudinal component along the modified second axis in the horizontal plane of the vehicle.

The processor [104] of the behaviour assessment device [100] is also configured to dynamically calculate a reorientation angle between one of a longitudinal axis and a lateral axis of the vehicle and one of the modified first axis and the modified second axis using a numerical reorientation technique based on minimizing lateral forces in the lateral axis of the vehicle for the vehicle driving straight with non-zero acceleration. For a measuring device [200] placed inside the vehicle, the present invention encompasses reorienting at least one first driving parameter received along the coordinate axes of the measuring device [200] to match the coordinate axes of the vehicle. Resultantly, the coordinate axes of the measuring device [200] are aligned with the coordinate axes of the vehicle irrespective of, firstly, the orientation of the measuring device [200] with respect to the coordinate axes of the vehicle and secondly, movement of the measuring device [200] within the vehicle. The numerical reorientation technique is further described with reference to FIG. 5. Referring to FIG. 3 illustrates the coordinate axes of a vehicle, being a longitudinal axis [302], a lateral axis [304] and a vertical axis [306]. While the exemplary vehicle illustrated in FIG. 3 is a car, the present invention is implementable in all vehicles.

In this regard, the present invention encompasses that the processor [104] of the behaviour assessment device [100] is configured to determine points of importance, required for reorienting the coordinate axes of the measuring device [200] to match the coordinate axes of the vehicle, knows as quality points in the at least one trip based on the at least one third driving parameter, wherein the quality points are updated considering only points above a threshold value. The present invention further encompasses that the vehicle substantially moves along the longitudinal axis of the vehicle at the quality points.

The processor [104] of the behaviour assessment device [100] is also configured to calculate an absolute mean value of each of the first component along the modified first axis and the second component along the modified second axis, i.e., the two acceleration components in horizontal plane of the vehicle, for the determined quality points. Further, the processor [104] of the behaviour assessment device [100] selects one of the modified first axis and the modified second axis as a modified longitudinal axis, and other of the modified first axis and the modified second axis as a modified lateral axis based on a comparison of the mean values of the first component along the modified first axis and the second component along the modified second axis. For example, the modified axis that has relatively higher absolute mean is chosen as aₓ [602] (as illustrated in FIG. 6) and the other axis is chosen as a_{y} [604] (as also illustrated in FIG. 6).

The processor [104] of the behaviour assessment device [100] is also configured to calculate, for the determined quality points, a plurality of sample driving parameters along the lateral axis of the vehicle based on a combination of the vectors (acceleration) in the horizontal plane of the vehicle for a plurality of angles within a range of 0 to 180 degrees. The plurality of sample driving parameters are calculated based on a vector component associated with the selected modified axis, for example, in an event the modified first axis is selected then the plurality of sample driving parameter are calculated based on the first component. The processor [104] of the behaviour assessment device [100] is also configured to select an angle between the plurality of angles within the range of 0 to 180 degrees as the reorientation angle, such that the sample driving parameter, at the reorientation angle is minimum along the lateral axis of the vehicle. The numerical reorientation of the present invention is further described with an illustration with reference to FIG. 5.

The processor [104] of the behaviour assessment device [100] is further configured to automatically calculate at least one second driving parameter along each of the longitudinal axis and the lateral axis of the vehicle based on a combination of the reorientation angle and a vector component of the at least one third driving parameter in the horizontal plane of the vehicle, (i.e., based on aₓ [602] and an ay [604]). The present invention encompasses that the processor [104] of the behaviour assessment device [100] calculates at least one second driving parameter corresponding to the at least one first driving parameter based on the reorientation angle. For example, an acceleration data in the coordinate axes of the measuring device [200] is received at the behaviour assessment device [100], the processor [104] determines an acceleration data in the coordinate axes of the vehicle based on the reorientation angle and the acceleration data in the coordinate axes of the measuring device [200]. In another example, a gyroscope data in the coordinate axes of the measuring device [200] is received at the behaviour assessment device [100], the processor [104] determines a corresponding gyroscope data in the coordinate axes of the vehicle based on the reorientation angle and the gyroscope data in the coordinate axes of the measuring device [200].

The processor [104] of the behaviour assessment device [100] is also configured to monitor the driving behaviour during a duration of the at least one trip based on the at least one second driving parameter along the coordinate axes of the vehicle, the coordinate axes of the vehicle comprising of the vertical axis, the longitudinal axis and the lateral axis of the vehicle. The present invention encompasses that the processor [104] of the behaviour assessment device [100] monitors the driving behaviour to monitor unsafe driving behaviour such as, but not just limited to, aggressive acceleration, applying sudden brakes, taking sharp and dangerous turns, over-speeding, driving fast over speed bumps and potholes, etc.

The processor [104] of the behaviour assessment device [100] is also configured to detect one or more events based on the at least one second driving parameter along the coordinate axes of the vehicle, and to determine a score for each of the one or more events. Further, the processor [104] of the behaviour assessment device [100] is also configured to determine a driving behaviour score based on a weighted average of the scores of the one or more events and the duration of the at least one trip. For instance, the behaviour assessment device [100] receives an acceleration data from the accelerometer of the measuring device [200], an orientation and an angular velocity from the gyroscope of the measuring device [200]. The present invention encompasses that the processor [104] of the behaviour assessment device [100] detects a completion of the at least one trip, for instance, based on a negative deceleration that a moving vehicle has come to rest, and accordingly, records the time duration of the trip from the initiation of the trip to the completion of the trip (e.g., using a timer). The processor [104] calculates scores for each individual event (acceleration, braking, cornering, speeding, etc) that it detects for the duration of the at least one trip. The driver behaviour score is further calculated as a weighted average of the scores for each of the event. The present invention encompasses that the individual event score also takes into account a frequency of the individual events, and a severity of the event adjudged on the at least one second parameter. For instance, if many such events are detected in a short span of the trip, the driver behaviour score for the event type is lesser than a driver for whom the same number of events were experienced fora trip but over a longer period of the trip duration than the first driver.

The present invention encompasses that the one or more events is one of an acceleration event, a hard braking event, a hard cornering event, a speeding event, a rider experience and a crash event. In an instance, the present invention encompasses that the processor [104] of the behaviour assessment device [100] detects the acceleration event and the hard braking event based on the at least one second driving parameter along the longitudinal axis of the vehicle. In another instance, the present invention encompasses that the processor [104] of the behaviour assessment device [100] detects the hard cornering event based on the gyroscope parameter. In yet another instance, the present invention encompasses that the processor [104] of the behaviour assessment device [100] the speeding event is detected based on the at least one second driving parameter along the longitudinal axis of the vehicle. For example, a speed data for the vehicle is calculated based on an integration of the at least one second driving parameter (acceleration based parameter) along the longitudinal axis of the vehicle, and the speeding event is detected based on a comparison of the calculated speed data with a threshold speed.

In yet another instance, the present invention encompasses that the processor [104] of the behaviour assessment device [100] detects the rider experience based on the at least one second driving parameter along the vertical axis of the vehicle. In this regard, the present invention encompasses that the processor [104] is also configured to detect high frequency components in at least one of the second driving parameters using one of a digital signal processing approaches. As the high frequency components captured in the driving parameters are caused by the vehicle being driven over a speed bump or potholes at high speeds, the difference between the sum of squares of the second driving parameter(s) and the parameter(s) after high frequency components are removed, is a measure of how uncomfortable the ride is for the passenger. The processor is further configured to map this difference to a score which can be termed a comfort score of the drive. In yet another instance, the present invention encompasses that the processor [104] of the behaviour assessment device [100] detects the crash event based on the at least one second driving parameter along at least one of the longitudinal axis and the lateral axis of the vehicle.

The processor [104] of the behaviour assessment device [100] is also configured to detect the one or more events using a pre-trained data model including but not just limited to machine learning techniques, statistical signal processing techniques, recurrent neural networks and other artificial intelligence techniques. The pre-trained data model comprises of pre-collected data including, but not limited to, sensor data received previously from numerous measuring devices [200]. The pre-trained data model also comprises of historical determination of the one or more events based on the previous sensor data. The processor [104] provides the at least one second driving parameter to the pre-trained data model. The pre-trained data model processes the at least one second driving parameter to the pre-trained data model to detect the one or more events. For instance, the pre-trained data model compares the at least one second driving parameter with the pre-trained data to detect the one or more events.

The processor [104] of the behaviour assessment device [100] is also configured to detect a deviation in the at least one first driving parameter from at least one of the accelerometer and the gyroscope of the measuring device [200] along at least one of the longitudinal axis, the vertical axis and the lateral axis of the measuring device [200]. Based on the detection, the processor [104] of the behaviour assessment device [100] is also configured to calculate the reorientation angle based on the deviation and the at least one second driving parameter. For example, upon detecting a deviation in the least one first driving parameter of the accelerator and the gyroscope when the measuring device [200] was moved, the process of the behaviour assessment device [100] recalculates the reorientation angle based on the deviation and the at least one second driving parameter. Thereafter, the processor [104] of the behaviour assessment device [100] recalculates the at least one second driving parameter based on the recalculated orientation angle, and lastly monitors the driving behaviour based on the at least one recalculated second driving parameter.

For example, the processor [104] of the behaviour assessment device [100] receives the at least one first driving parameter after completion of the trip. The processor [104] of the behaviour assessment device [100] divides the trip into one or more segments, and processes the one or more segments, iteratively, to determine if the measuring device [200] was moved, i.e., detect any deviation in the least one first driving parameter. In an event a deviation is detected, the processor [104] of the behaviour assessment device [100] recalculates the reorientation angle based on the deviation and the at least one second driving parameter for each of the one or more segments. The processor [104] of the behaviour assessment device [100] also recalculates the at least one second driving parameter for each of the one or more segments of the trip based on the recalculated reorientation angle of that segment. Subsequently, the processor [104] of the behaviour assessment device [100] monitors the driving behaviour based on the at least one recalculated second driving parameter for the one or more segments of the trip.

The memory unit [106] of the behaviour assessment device [100] is configured to store the at least one first driving parameter, the reorientation angle, the at least one second driving parameter and the detected one or more events at a memory unit [106] of the behaviour assessment device [100].

Referring to FIG. 2 illustrates a system for monitoring a driving behaviour using a behaviour assessment device [100], in accordance with the exemplary embodiments of the present invention. The system comprises of the measuring device [200] and the behaviour assessment device [100]. In an instance of the present invention, the behaviour assessment device [100] is connected to the measuring device [200] over a wired or a wireless connection. The measuring device [200] comprises at least an accelerometer [202], a gyroscope [204]. The measuring device [200] is configured to collect at least one first driving parameter from at least one of the accelerometer and the gyroscope of the measuring device [200] along at least one of the longitudinal axis, the vertical axis and the lateral axis of the measuring device [200]. The measuring device [200] is further configured to transmit the at least one first driving parameter along at least one of the longitudinal axis, the vertical axis and the lateral axis of the measuring device [200] to the behaviour assessment device [100]. The present invention encompasses that the measuring device [200], in an instance, is a user device capable of collecting the at least one first driving parameter from at least one of the accelerometer and the gyroscope. The user device is further capable of connecting with the behaviour assessment device [100], and of transmitting the at least one first driving parameter to the behaviour assessment device [100].

As also explained above in reference to FIG. 1, the behaviour assessment device [100] further comprises the transceiver unit [102], the memory unit [106] and the processor [104]. The transceiver unit [102] is configured to receive at least one first driving parameter from at least one of the accelerometer and the gyroscope of the measuring device [200] along at least one of the longitudinal axis, the vertical axis and the lateral axis of the measuring device [200]. The processor [104] is configured to detect an initiation of at least one trip on a vehicle based on the at least one first driving parameter. The processor [104] is configured to calculate at least one third driving parameter along a modified first axis and a modified second axis in a horizontal plane of the vehicle based on the at least one first driving parameter. The processor [104] is also configured to dynamically calculate a reorientation angle between one of a longitudinal axis and a lateral axis of the vehicle and one of the modified first axis and the modified second axis using a numerical reorientation technique based on minimizing lateral forces in the lateral axis of the vehicle for the vehicle driving straight with non-zero acceleration. The processor [104] is also configured to automatically calculate at least one second driving parameter along each of the longitudinal axis and the lateral axis of the vehicle based on a combination of the reorientation angle and a vector component of the at least one third driving parameter. The processor [104] is also configured to monitor the driving behaviour during a duration of the at least one trip based on the at least one second driving parameter along the coordinate axes of the vehicle.

Referring to FIG. 4 illustrates an exemplary flow diagram depicting a method [400] for monitoring a driving behaviour using a behaviour assessment device [100], in accordance with exemplary embodiments of the present invention. The method starts at step [402]. The present invention encompasses that the method [400] is initiated, for an instance, after a trip on a vehicle is completed to assess the driving behaviour for a driver of the vehicle for at least one trip. In another instance, the present invention encompasses that the method [400] is initiated upon initiation of a trip. In yet another instance, the present invention encompasses that the method [400] is initiated for an ongoing trip.

At step [404], the method [400] comprises receiving at least one first driving parameter from at least one of the accelerometer and the gyroscope of the measuring device [200] along at least one of the longitudinal axis, the vertical axis and the lateral axis of the measuring device [200] at the transceiver unit [102] of the behaviour assessment device [100]. The present invention encompasses that the at least one first driving parameter is the acceleration in at least one of the longitudinal axis, the vertical axis and the lateral axis of the measuring device [200] as measured by the accelerometer of the measuring device [200]. The present invention encompasses that the at least one first driving parameter is an angular velocity as measured by the gyroscope of the measuring device [200]. The present invention encompasses that the transceiver unit [102] of the behaviour assessment device [100] receives the at least one first driving parameter, for instance, continuously. In another instance the present invention encompasses that the transceiver unit [102] of the behaviour assessment device [100] receives the at least one first driving parameter periodically. The method [400] at step [402] further encompasses that the transceiver unit [102] transmits the received at least one first driving parameter to the processor [104] of the behaviour assessment device [100].

Next, at step [406], the processor [104] of the behaviour assessment device [100] receives the at least one first driving parameter from the transceiver unit [102] of the behaviour assessment device [100], wherein the at least one first driving parameter is received from at least one of the accelerometer and the gyroscope of the measuring device [200] in at least one of the longitudinal axis, the vertical axis and the lateral axis of the measuring device [200]. The processor [104] of the behaviour assessment device [100] detects an initiation of at least one trip on a vehicle. For example, for a vehicle initially at rest, the processor [104] detects an initiation of a trip for the vehicle based on the at least one first driving parameters. In another instance, the present invention encompasses that the processor [104] of the behaviour assessment device [100] detects an initiation of the at least one trip on a vehicle based on an input received from an interface of the vehicle, wherein the processor [104] is configured to communicate with the vehicles' interface. Thereafter, the processor [104] of the behaviour assessment device [100] proceeds to next steps.

Further, at step [408], the processor [104] of the behaviour assessment device [100] calculates at least one third driving parameter along a modified first axis and a modified second axis in a horizontal plane of the vehicle based on the at least one first driving parameter. Separating the gravity in one axis (say, vertical axis) of the coordinate axes of the measuring device also affects the at least one first driving parameters (other vector components) in other two axes (lateral and longitudinal axes) also, thus, generating new vector components.

Subsequently, at step [410], the processor [104] of the behaviour assessment device [100] dynamically calculates a reorientation angle between one of a longitudinal axis and a lateral axis of the vehicle and the modified first axis and the modified second axis using a numerical reorientation technique based on minimizing lateral forces in the lateral axis of the vehicle for the vehicle driving straight with non-zero acceleration. For a measuring device [200] placed inside the vehicle, the present invention encompasses reorienting the at least one first driving parameter collected along the coordinate axes of the measuring device [200] to match the coordinate axes of the vehicle. Resultantly, the coordinate axes of the measuring device [200] are aligned with the coordinate axes of the vehicle irrespective of, firstly, the orientation of the measuring device [200] with respect to the coordinate axes of the vehicle and secondly, movement of the measuring device [200] within the vehicle. The numerical reorientation technique is further described with reference to FIG. 5. Referring to FIG. 3 illustrates the coordinate axes of a vehicle, being a longitudinal axis [302], a lateral axis [304] and a vertical axis [306]. While the exemplary vehicle illustrated in FIG. 3 is a car, the present invention is implementable in all vehicles.

Further, at step [412], the processor [104] of the behaviour assessment device [100] automatically calculates at least one second driving parameter along each of the longitudinal axis and the lateral axis of the vehicle based on a combination of the reorientation angle and a vector component of the at least one third driving parameter. The present invention encompasses that the processor [104] of the behaviour assessment device [100] calculates at least one second driving parameter corresponding to each of the at least one first driving parameter based on the reorientation angle calculated at step [408]. For example, an acceleration data in the coordinate axes of the measuring device [200] is received at the behaviour assessment device [100], the processor [104] determines an acceleration data in the coordinate axes of the vehicle based on the reorientation angle and the acceleration data in the coordinate axes of the measuring device [200]. In another example, a gyroscope data in the coordinate axes of the measuring device [200] is received at the behaviour assessment device [100], the processor [104] determines a corresponding gyroscope data in the coordinate axes of the vehicle based on the reorientation angle and the gyroscope data in the coordinate axes of the measuring device [200].

Furthermore, at step [414], the processor [104] of the behaviour assessment device [100] monitors the driving behaviour during a duration of the at least one trip based on the at least one second driving parameter along the coordinate axes of the vehicle. The present invention encompasses that the processor [104] of the behaviour assessment device [100] monitors the driving behaviour to monitor unsafe driving behaviour such as, but not just limited to, aggressive acceleration, applying sudden brakes, taking sharp and dangerous turns, over-speeding, driving fast over speed bumps and potholes, etc. The method completes at step [416].

The method [400] of the present invention encompasses that the step [408] of calculating, by the processor [104] of the behaviour assessment device [100], the at least one third driving parameter along a modified first axis and a modified second axis in a horizontal plane of the vehicle based on the at least one first driving parameter further comprises determining a vertical reorientation angle between the vertical axis of the measuring device [200] and the vertical axis of the vehicle by the processor [104] of the behaviour assessment device [100]. Further, the processor [104] of the behaviour assessment device [100] calculates the at least one second driving parameter along the vertical axis of the vehicle based on the at least one first driving parameter along the vertical axis of the measuring device [200] and the vertical reorientation angle. The processor [104] of the behaviour assessment device [100] separates the gravity to a known axis using the at least one first driving parameters received from the gyroscope and the accelerometer of the measuring device [200], thus, aligning the coordinate axes of the measuring device with the gravity using trigonometric identities and vector algebra techniques.

Accordingly, the processor [104] of the behaviour assessment device [100] further calculates at least one third driving parameter along the modified first axis and the modified second axis in a horizontal plane of the vehicle based on a combination of at least one first driving parameter and the above calculated at least one second driving parameter of the vertical axis of the vehicle, wherein the at least one third driving parameter comprises of a first component along the modified first axis and longitudinal component along the modified second axis in the horizontal plane of the vehicle.

The method [400] of the present invention encompasses that the step [410] of dynamically calculating the reorientation angle further comprises determining points of importance, required for reorienting the coordinate axes of the measuring device [200] to match the coordinate axes of the vehicle, known as quality points in the at least one trip based on the at least one third driving parameter, wherein the quality points are updated considering only points above a threshold value. The present invention further encompasses that the vehicle substantially moves along the longitudinal axis of the vehicle at the quality points. Next, the processor [104] of the behaviour assessment device [100] calculates an absolute mean value for each of the first component along the modified first axis and the second component along the modified second axis, i.e., the two acceleration components in horizontal plane of the vehicle, for the determined quality points. Further, the processor [104] of the behaviour assessment device [100] selects one of the modified first axis and the modified second axis as a modified longitudinal axis, and other of the modified first axis and the modified second axis as a modified lateral axis based on a comparison of the mean values of the first component along the modified first axis and the second component along the modified second axis. For example, the modified axis that has relatively higher absolute mean is chosen as aₓ [602] (as illustrated in FIG. 6) and the other axis is chosen as ay [604] (as also illustrated in FIG. 6).

Subsequently, the processor [104] of the behaviour assessment device [100] calculates, for the determined quality points, a plurality of sample driving parameters along the selected modified axis of the vehicle based on a combination of the vector component of the at least one third driving parameter and a plurality of angles within a range of 0 to 180 degrees. The plurality of sample driving parameters are calculated based on a vector component associated with the selected modified axis, for example, in an event the modified first axis is selected then the plurality of sample driving parameter are calculated based on the first component. Further, the processor [104] of the behaviour assessment device [100] selects an angle between the plurality of angles within the range of 0 to 180 degrees as the reorientation angle, such that the sample driving parameter at the reorientation angle is minimum along the lateral axis of the vehicle. The numerical reorientation of the present invention is further described in detail with reference to FIG. 5.

The present invention encompasses that step [412] of the method [400], monitoring the driving behaviour by the processor [104] of the behaviour assessment device [100] further comprises detecting one or more events based on at least one of the at least one second driving parameter along the coordinate axes of the vehicle, and determining a score for each of the one or more events. Further, the processor [104] of the behaviour assessment device [100] determines a driving behaviour score based on a weighted average of the scores of the one or more events, a frequency of the one or more events and the duration of the at least one trip. For instance, the behaviour assessment device [100] receives an acceleration data from the accelerometer of the measuring device [200], an orientation and an angular velocity from the gyroscope of the measuring device [200]. The present invention encompasses that the processor [104] of the behaviour assessment device [100] detects a completion of the at least one trip, for instance, based on a negative deceleration that a moving vehicle has come to rest or the vehicle's interface, and accordingly, records the time duration of the trip from the initiation of the trip to the completion of the trip (e.g., using a timer). The processor [104] calculates scores for each individual event (acceleration, braking, cornering, speeding, etc) that it detects for the duration of the at least one trip. The driver behaviour score is further calculated as a weighted average of the scores for each of the event. The present invention encompasses that the individual event score also takes into account a frequency of the individual events, and a severity of the event adjudged on the at least one second parameter. For instance, if many such events are detected in a short span of the trip, the driver behaviour score for the event type is lesser than a driver for whom the same number of events were experienced for a trip but over a longer period of the trip duration than the first driver.

The present invention encompasses that the one or more events is one of an acceleration event, a hard braking event, a hard cornering event, a speeding event, a rider experience and a crash event. In an instance, the present invention encompasses that the processor [104] of the behaviour assessment device [100] detects the acceleration event and the hard braking event based on the at least one second driving parameter along the longitudinal axis of the vehicle. In another instance, the present invention encompasses that the processor [104] of the behaviour assessment device [100] detects the hard cornering event based on the gyroscope parameter. In yet another instance, the present invention encompasses that the processor [104] of the behaviour assessment device [100] detects the speeding event is detected based on the at least one second driving parameter along the longitudinal axis of the vehicle. For example, a speed data for the vehicle is calculated based on an integration of the at least one second driving parameter (acceleration based parameter) along the longitudinal axis of the vehicle, and the speeding event is detected based on a comparison of the calculated speed data with a threshold speed.

In yet another instance, the present invention encompasses that the processor [104] of the behaviour assessment device [100] detects the rider experience based on the at least one second driving parameter along the vertical axis of the vehicle. In this regard, the present invention encompasses that the processor [104] is also configured to detect high frequency components in at least one of the second driving parameters using one of a digital signal processing approaches. As the high frequency components captured in the driving parameters are caused by the vehicle being driven over a speed bump or potholes at high speeds, the difference between the sum of squares of the second driving parameter(s) and the parameter(s) after high frequency components are removed, is a measure of how uncomfortable the ride is for the passenger. The processor is further configured to map this difference to a score which can be termed a comfort score of the drive. In yet another instance, the present invention encompasses that the processor [104] of the behaviour assessment device [100] detects the crash event based on the at least one second driving parameter along at least one of the longitudinal axis and the lateral axis of the vehicle.

The method [400] of the present invention further encompasses that the processor [104] of the behaviour assessment device [100] detects the one or more events using a pre-trained data model. The pre-trained data model comprises of pre-collected data including, but not limited to, sensor data received previously from numerous measuring devices [200]. The pre-trained data model also comprises of historical determination of the one or more events based on the previous sensor data. The processor [104] provides the at least one second driving parameter to the pre-trained data model. The pre-trained data model processes the at least one second driving parameter r to the pre-trained data model to detect the one or more events. For instance, the pre-trained data model compares the at least one second driving parameter with the pre-trained data to detect the one or more events.

The method [400] of the present invention also encompasses that upon the processor [104] of the behaviour assessment device [100] detecting a deviation in the at least one first driving parameter from at least one of the accelerometer and the gyroscope of the measuring device [200] along at least one of the longitudinal axis, the vertical axis and the lateral axis of the measuring device [200], the method [400] further comprises calculating the reorientation angle based on the deviation and the at least one second driving parameter. For example, upon detecting a deviation in the least one first driving parameter, when the measuring device [200] was moved, the process of the behaviour assessment device [100] recalculates the reorientation angle based on the deviation and the at least one second driving parameter. Thereafter, the method proceeds to step [410] and the processor [104] of the behaviour assessment device [100] recalculates the at least one second driving parameter based on the recalculated orientation angle, and lastly monitors the driving behaviour based on the at least one recalculated second driving parameter.

In an instance, the method of the present invention also encompasses that the processor [104] of the behaviour assessment device [100] receives the at least one first driving parameter from the measuring device [200] after completion of the trip. The processor [104] of the behaviour assessment device [100] divides the trip into one or more segments, and processes the one or more segments, iteratively, to determine if the measuring device [200] was moved, i.e., detect any deviation in the least one first driving parameter. In an event a deviation is detected, the processor [104] of the behaviour assessment device [100] recalculates the reorientation angle based on the deviation and the at least one second driving parameter for each of the one or more segments. The processor [104] of the behaviour assessment device [100] also recalculates the at least one second driving parameter for each of the one or more segments of the trip based on the recalculated reorientation angle of that segment. Subsequently, the processor [104] of the behaviour assessment device [100] monitors the driving behaviour based on the at least one recalculated second driving parameter for the one or more segments of the trip.

The method [400] of the present invention also encompasses storing the at least one first driving parameter, the reorientation angle, the at least one second driving parameter and the detected one or more events at a memory unit [106] of the behaviour assessment device [100].

Referring to FIG. 5 illustrates an exemplary numerical reorientation sub-method of the present invention, in accordance with exemplary embodiments of the present invention. The numerical reorientation sub-method is based on, firstly, separating gravity to a known axis using gyroscope and accelerometer parameter of the measuring device [200] and alignment of the accelerometer with gravity using trigonometric identities and vector algebra, and secondly, separating the lateral acceleration from longitudinal acceleration of the vehicle based on the fact that the lateral forces (i.e., acceleration, etc.) acting on a vehicle are minimum when it's traveling in a straight path. Referring to FIG. 6 illustrates an exemplary vector representation of the acceleration in the horizontal plane of the vehicle. Illustrated in FIG. 6 are the remaining two acceleration components in the horizontal plane after aligning one component with the vertical axis of the vehicle collected from measuring device [200], Illustrated in FIG. 6 are the two components of acceleration in the horizontal plane, aₓ and a_{y}. FIG. 6 also illustrates the longitudinal axis of the vehicle [302] and the lateral axis of the vehicle [304].

The sub-method starts at step [502]. The present invention encompasses that the sub-method starts upon the processor [104] of the behaviour assessment device [100] detecting initiation of the at least one trip. At step [504], the processor [104] of the behaviour assessment device [100] determines quality points in the at least one trip based on the at least one third driving parameter along the horizontal plane of the vehicle [300]. The processor [104] of the behaviour assessment device [100] determines the points where the vehicle is accelerating, decelerating and moving straight. In an instance, to determine whether the vehicle is accelerating or decelerating the processor [104] compares the resultant net horizontal acceleration components (the first and the second component) to a threshold value. In another instance, to determine whether the vehicle is moving straight, the processor [104] compares the parameters associated with the gyroscope to a threshold gyroscope value. Accordingly, the points isolated from step [504] are hereafter referred to as quality points (qᵢ).

Further, at step [506], the processor [104] of the behaviour assessment device [100] calculates, for the determined quality points, an absolute mean value of each of the two acceleration components (the first and the second components) in the horizontal plane for the determined quality points. The processor [106] selects one of the modified first axis and the modified second axis as a modified longitudinal axis, and other of the modified first axis and the modified second axis as a modified lateral axis based on a comparison of the mean values of the first component along the modified first axis and the second component along the modified second axis. The axis that has relatively higher absolute mean is chosen as aₓ [602] in FIG. 6 and the other axis is chosen as a_{y} [604] so that the component of forces along aₓ are greater than the component of forces along a_{y} when the vehicle is moving forward with non-zero acceleration.

Furthermore, at step [508], the quality points, qi, can be further refined in a way that, only one kind of force is taken into account while calculating the angle theta, either braking or acceleration events, whichever happens more frequently. In an instance we consider both accelerating and decelerating forces in computation, they might cancel out, and may lead to an incorrect reorientation angle.

At step [510], the processor [104] of the behaviour assessment device [100] calculates, for the determined quality points, a plurality of sample driving parameters along the lateral axis of the vehicle based on a combination of the vectors along the selected modified lateral axis in the horizontal plane of the vehicle [300] and a plurality of angles within a range of 0 to 180 degrees based on the below equation (1).

aₗₐₜₑᵣₐₗ=a_{y} cos θ−aₓ sin θ

At step [512], the processor [104] of the behaviour assessment device [100] computes a sum of the lateral components of acceleration (aₗₐₜₑᵣₐₗ) for all the quality points for each of the arbitrary angle theta (θ) between 0 and 180 degrees. The angle that provides the minimum value of the sum of the aₗₐₜₑᵣₐₗ is one of the two possible solutions for reorientation angle.

Furthermore, at step [514], the processor [104] of the behaviour assessment device [100] selects an angle between the plurality of angles within the range of 0 to 180 degrees as the reorientation angle, such that the sample driving parameter at the reorientation angle is minimum along the lateral axis of the vehicle. The processor [104] of the behaviour assessment device [100] determines the actual angle from the two possible solutions, obtained in [512], between aₓ and longitudinal axis of vehicle. Since an angle 360−θ produces the same magnitude of lateral acceleration, the actual angle is computed based on the reoriented gyroscope parameter computed while removing gravity that will also have the same direction as the actual lateral acceleration component. The sample driving parameter is multiplied by reoriented gyroscope parameter for all the quality points for angle θ and 360−θ, the angle at which the sum of the multiplication of sample driving parameter for all the quality points is positive will be the actual angle between ax [602] and longitudinal axis of the vehicle [302], known as reorientation angle ° reorient.

For instance, the processor [104] computes aₗₐₜₑᵣₐₗ at angle (θ) and aₗₐₜₑᵣₐₗ at angle (360−θ), and multiplies them with the reoriented gyroscope values. Whichever angle gives positive value will be the actual angle of reorientation (θᵣₑₒᵣᵢₑₙₜ) between the acceleration component ax [602] and the longitudinal axis of the vehicle [302]. The sub-method completes at step [516].

The present invention further encompasses that the processor [104] of the behaviour assessment device [100] automatically calculates at least one second driving parameter along each of the longitudinal axis and the lateral axis of the vehicle based on a combination of the reorientation angle θᵣₑₒᵣᵢₑₙₜ and a vector component of the at least one first driving parameter at the horizontal plane of the vehicle. For example, the processor [104] reorients the acceleration components aₓ and a_{y} data based on the reorientation angle (θᵣₑₒᵣᵢₑₙₜ) and computes aₗₐₜₑᵣₐₗ (along [304]) and a_{longitudinal} (along [302]) using equations (2) and (3) respectively.

aₗₐₜₑᵣₐₗ=a_{y} cos θᵣₑₒᵣᵢₑₙₜ−aₓ sin θᵣₑₒᵣᵢₑₙₜ (2)

a_{longitudinal}=aₓ cos θᵣₑₒᵣᵢₑₙₜ+a_{y} sin θᵣₑₒᵣᵢₑₙₜ (3)

The novel solution of the present invention provides a system and a method for monitoring a driving behaviour using a behaviour assessment device. Particularly, the solution of the present invention cures the limitation of the existing solutions by providing monitoring a driving behaviour using a behaviour assessment device in a GPS-denied environment. The present invention also provides that a driving score is derived based on the monitoring to generate reports that further help in improvising rider comfort and safety.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the invention herein, whereby it is to be distinctly understood that the foregoing descriptive matter to be implemented merely as illustrative of the invention and not as limitation.

1. A method for monitoring a driving behaviour using a behaviour assessment device in a GPS denied environment, the method comprising:
receiving, at a transceiver unit of the behaviour assessment device, at least one first driving parameter from at least one of an accelerometer and a gyroscope of a measuring device along at least a longitudinal axis, a vertical axis and a lateral axis of the measuring device;
detecting, by a processor of the behaviour assessment device, an initiation of at least one trip on a vehicle;
calculating, by the processor of the behaviour assessment device, at least one third driving parameter along a modified first axis and a modified second axis in a horizontal plane of the vehicle based on the at least one first driving parameter;
dynamically calculating, by the processor of the behaviour assessment device, a reorientation angle between at least one of a longitudinal axis and a lateral axis of the vehicle and one of the modified first axis and the modified second axis using a numerical reorientation technique based on minimizing lateral forces in the lateral axis of the vehicle for the vehicle driving straight with non-zero acceleration;
automatically calculating, by the processor of the behaviour assessment device, at least one second driving parameter along each of the longitudinal axis and the lateral axis of the vehicle based on a combination of the reorientation angle and a vector component of the at least one third driving parameter; and
monitoring, by the processor of the behaviour assessment device, the driving behaviour during a duration of the at least one trip based on the at least one second driving parameter along a coordinate axes of the vehicle.

2. The method as claimed in claim 1, wherein calculating, by the processor of the behaviour assessment device, the at least one third driving parameter along a modified first axis and a modified second axis in a horizontal plane of the vehicle based on the at least one first driving parameter further comprises:
determining, by the processor of the behaviour assessment device, a vertical reorientation angle between the vertical axis of the measuring device and a vertical axis of the vehicle;
calculating, by the processor of the behaviour assessment device, the at least one second driving parameter along the vertical axis of the vehicle based on the vertical reorientation angle and the at least one first driving parameter in the vertical axis of the measuring device;
calculating, by the processor of the behaviour assessment device, at least one third driving parameter along the modified first axis and the modified second axis in a horizontal plane of the vehicle based on a combination of at least one first driving parameter and the above calculated at least one second driving parameter in the vertical axis of the vehicle, wherein the at least one third driving parameter comprises of a first component along the modified first axis and a second component along the modified second axis in the horizontal plane of the vehicle.

3. The method as claimed in claim 1, wherein dynamically calculating the reorientation angle further comprises:
determining quality points in the at least one trip based on the at least one third driving parameter;
calculating, for the determined quality points, an absolute mean value for each of the first component in the modified first axis and the second component in the modified second axis;
selecting one of the modified first axis and the modified second axis as a modified longitudinal axis, and other of the modified first axis and the modified second axis as a modified lateral axis based on a comparison of the mean values of the first component along the modified first axis and the second component along the modified second axis;
calculating, for the determined quality points, a plurality of sample driving parameters along the selected modified lateral axis based on a combination of the vector component in the selected modified lateral axis and a plurality of angles within a range of 0 to 180 degrees; and
selecting an angle between the plurality of angles within the range of 0 to 180 degrees as the reorientation angle, such that the sample driving parameter at the reorientation angle is minimum along the lateral axis of the vehicle.

4. The method as claimed in claim 1, wherein monitoring the driving behaviour further comprises:
detecting one or more events based on the at least one second driving parameter along the coordinate axes of the vehicle; and
determining a score for each of the one or more events.

5. The method as claimed in claim 4, wherein the one or more events is one of an acceleration event and a hard braking event, said acceleration event and the hard braking event are detected based on the at least one second driving parameter along the longitudinal axis of the vehicle,
the one or more events is a hard cornering event, said hard cornering is detected based on the at least one second driving parameter, and
the one or more events is a speeding event, said speeding event is detected based on the at least one second driving parameter along the longitudinal axis of the vehicle.

6-8. (canceled)

9. The method as claimed in claim 4, wherein the one or more events is a crash event, and the crash event is detected based on the at least one second driving parameter along at least one of the longitudinal axis and the lateral axis of the vehicle.

10. The method as claimed in claim 4, further comprising determining a driving behaviour score based on a weighted average of the scores of the one or more events, a frequency of the one or more events and a duration of the at least one trip.

11. The method as claimed in claim 1, the method further comprising:
detecting, by the processor of the behaviour assessment device, a deviation in the at least one first driving parameter received from at least one of the accelerometer and the gyroscope of the measuring device along at least the longitudinal axis, the vertical axis and the lateral axis of the measuring device; and
calculating, by the processor of the behaviour assessment device, the reorientation angle based on the deviation and the at least one second driving parameter.

12. A behaviour assessment device comprising:
a memory unit;
a transceiver unit connected to the memory unit, said transceiver unit configured to receive at least one first driving parameter from at least one of an accelerometer and a gyroscope of a measuring device along at least a longitudinal axis, a vertical axis and a lateral axis of the measuring device;
a processor connected to the transceiver unit and the memory unit, said processor configured to:
detect an initiation of at least one trip on a vehicle,
calculate at least one third driving parameter along a modified first axis and a modified second axis in a horizontal plane of the vehicle based on the at least one first driving parameter,
dynamically calculate a reorientation angle between at least one of a longitudinal axis and a lateral axis of the vehicle and one of the modified first axis and the modified second axis using a numerical reorientation technique based on minimizing lateral forces in the lateral axis of the vehicle for the vehicle driving straight with non-zero acceleration,
automatically calculate at least one second driving parameter along each of the longitudinal axis and the lateral axis of the vehicle based on a combination of the reorientation angle and a vector component of the at least one third driving parameter, and
monitor the driving behaviour during a duration of the at least one trip based on the at least one second driving parameter along a coordinate axes of the vehicle.

13. The behaviour assessment device as claimed in claim 12, wherein the processor of the behaviour assessment device is further configured to:
determine a vertical reorientation angle between the vertical axis of the measuring device and the vertical axis of the vehicle;
calculate the at least one second driving parameter along the vertical axis of the vehicle based on the at least one first driving parameter along the vertical axis of the measuring device and the vertical reorientation angle; and
calculate at least one third driving parameter along the modified longitudinal axis and the modified lateral axis in a horizontal plane of the vehicle based on a combination of at least one first driving parameter and the above calculated at least one second driving parameter of the vertical axis of the vehicle, wherein the at least one third driving parameter comprises of a first component (aₓ) along the modified lateral axis and longitudinal component (a_{y}) along the modified longitudinal axis in the horizontal plane of the vehicle.

14. The behaviour assessment device as claimed in claim 12, wherein the processor of the behaviour assessment device is further configured to:
determine quality points in the at least one trip based on the at least one third driving parameter;
calculate, for the determined quality points, an absolute mean value of each of the first component along the modified first axis and the second component along the modified second axis
select one of the modified first axis and the modified second axis as a modified longitudinal axis, and other of the modified first axis and the modified second axis as a modified lateral axis based on a comparison of the mean values of the first component along the modified first axis and the second component along the modified second axis;
calculate, for the determined quality points, a plurality of sample driving parameters along the selected modified lateral axis based on a combination of the vector component along the selected modified lateral axis and a plurality of angles within a range of 0 to 180 degrees; and
select an angle between the plurality of angles within the range of 0 to 180 degrees as the reorientation angle, such that the sample driving parameter at the reorientation angle is minimum along the lateral axis of the vehicle.

15. The behaviour assessment device as claimed in claim 12, wherein the processor of the behaviour assessment device is further configured to:
detect one or more events based the at least one second driving parameter along the coordinate axes of the vehicle; and
determine a score for each of the one or more events.

16. The behaviour assessment device as claimed in claim 15, wherein:
the one or more events is one of an acceleration event and a hard braking event, and the acceleration event and the hard braking event are detected based on the at least one second driving parameter along the longitudinal axis of the vehicle,
the one or more events is a hard cornering event, and the hard cornering is detected based on the at least one second driving parameter, and
the one or more events is a speeding event, and the speeding event is detected based on the at least one second driving parameter along the longitudinal axis of the vehicle.

17-19. (canceled)

20. The behaviour assessment device as claimed in claim 15, wherein the one or more events is a crash event, and the crash event is detected based on the at least one second driving parameter along at least one of the longitudinal axis and the lateral axis of the vehicle.

21. The behaviour assessment device as claimed in claim 12, further comprising determining a driving behaviour score based on a weighted average of the scores of the one or more events, a frequency of the one or more events and the duration of the at least one trip.

22. The behaviour assessment device as claimed in claim 12, wherein the processor of the behaviour assessment device is further configured to:
detecting, by the processor of the behaviour assessment device, a deviation in the at least one first driving parameter received from at least one of the accelerometer and the gyroscope of the measuring device along at least one of the longitudinal axis, the vertical axis and the lateral axis of the measuring device; and
calculating the reorientation angle based on the deviation and the at least one second driving parameter.

23. The behaviour assessment device as claimed in claim 12, wherein the behaviour assessment device is one of a standalone device and integrally installed in the measuring device.

24. A system for monitoring a driving behaviour using a behaviour assessment device in a GPS denied environment, the system comprising:
a measuring device further comprising at least one of an accelerometer and a gyroscope, said measuring device configured to:
collect at least one first driving parameter from at least one of the accelerometer and the gyroscope of the measuring device along at least one of a longitudinal axis, a vertical axis and a lateral axis of the measuring device, and
transmit, to the behaviour assessment device, the at least one first driving parameter along at least one of the longitudinal axis, the vertical axis and the lateral axis of the measuring device; and
the behaviour assessment device further comprising:
a memory unit;
a transceiver unit connected to the memory unit, said transceiver unit configured to receive at least one first driving parameter from at least one of the accelerometer and the gyroscope of the measuring device along at least one of the longitudinal axis, the vertical axis and the lateral axis of the measuring device;
a processor connected to the transceiver unit and the memory unit, said processor configured to:
detect an initiation of at least one trip on a vehicle,
calculate at least one third driving parameter along a modified first axis and a modified second axis in a horizontal plane of the vehicle based on the at least one first driving parameter,
dynamically calculate a reorientation angle between at least one a longitudinal axis and a lateral axis of the vehicle and one of the modified first axis and the modified second axis using a numerical reorientation technique based on minimizing lateral forces in the lateral axis of the vehicle for the vehicle driving straight with non-zero acceleration,
automatically calculate at least one second driving parameter along each of the longitudinal axis and the lateral axis of the vehicle based on a combination of the reorientation angle and a vector component of the at least one third driving parameter, and
monitor the driving behaviour during a duration of the at least one trip based on the at least one second driving parameter along a coordinate axes of the vehicle.
